(19) United States
(12) Patent Application Publication
(10) Pub. No.: US 2021/0010521 A1
(43) Pub. Date: Jan. 14, 2021

(54) CONNECTION STRUCTURE HAVING DUMBBELL-SHAPED BIDIRECTIONAL TAPERED EXTERNAL THREAD AND TRADITIONAL THREAD HAVING LARGE LEFT TAPER AND SMALL RIGHT TAPER

(71) Applicant: AMICUS VERITATIS MACHINERY CO., LTD., Taizhou (CN)

(72) Inventor: Yihua YOU, TAIZHOU (CN)

(21) Appl. No.: 17/036,197

(22) Filed: Sep. 29, 2020

Related U.S. Application Data
(63) Continuation of application No. PCT/CN2019/081391, filed on Apr. 4, 2019.

(30) Foreign Application Priority Data
Apr. 7, 2019 (CN) 201810303093.3

(51) Int. Cl. F16B 35/04

(52) U.S. Cl. CPC F16B 35/041

(57) ABSTRACT

Disclosed is a connection structure having a dumbbell-shaped bidirectional tapered external thread and a traditional thread having a large left taper and a small right taper. The connection structure includes an external thread (9) which is a dumbbell-shaped (94) bidirectional truncated cone (71) having a small middle and two large ends, wherein an outer surface of a columnar body (3) is a spiral and the left taper (95) of a complete unit body thread is larger than the right taper (96), having the ability to assimilate a traditional internal thread (6). After being assimilated, the internal thread (6) is a special tapered hole (4) of a cylindrical body (2) an inner surface of which is a spiral. The present invention solves the problems of existing threads having poor self-positioning and self-locking, the performance mainly depending on the conical surface and taper size of the thread body.

### CROSS-REFERENCE TO RELATED APPLICATIONS

This application is a continuation of International Patent Application No. PCT/CN2019/081391, filed on Apr. 4, 2019, entitled “CONNECTION STRUCTURE HAVING DUMBBELL-SHAPED BIDIRECTIONAL TAPERED EXTERNAL THREAD AND TRADITIONAL THREAD HAVING LARGE LEFT TAPER AND SMALL RIGHT TAPER,” which claims priority to China Patent Application No. 201810303093.3, filed on Apr. 7, 2018. The content of these identified applications are hereby incorporated by references.

### TECHNICAL FIELD

The disclosure relates to the technical field of general technology of devices, and more specifically, to a connection structure having a dumbbell-shaped bidirectional tapered external thread and a traditional thread having a large left taper and a small right taper, which is connection structure having a dumbbell-shaped (the left taper is greater than the right taper) asymmetric bidirectional tapered external thread and a traditional thread (hereinafter referred to as “a bidirectional tapered external thread and a traditional thread”).

### BACKGROUND

The invention of the thread has a profound impact on the progress of human society. Thread is one of the most basic industrial technologies. It is not a specific product, but a key common technology in the industry. Its technical performance must be embodied by a specific product as an application carrier, and it is widely used in various industries. The existing thread technology has a high level of standardization, mature technical theory, and long-term practical application. When used for fastening, it is a fastening thread; when it is used for sealing, it is a sealing thread; when it is used for transmission, it is a transmission thread. According to the national standard thread terminology: “thread” refers to a tooth on the surface of a cylinder or cone that has the same tooth profile and continuously bulges along a spiral line; “tooth” refers to the material entity between adjacent flanks. This is also the threaded definition known by the world.

The modern thread began in 1841 with the British Whitworth thread. According to modern thread technology theory, the basic condition for thread self-locking is as follows: the equivalent friction angle should not be less than the lead angle. This is an understanding of the modern thread technology based on its technical principle, that is, “inclined plane principle”, which has become an important theoretical basis for the modern thread technology. Steven made a theoretical explanation of the inclined plane principle first. He researched and discovered the conditions for the balance of objects on the inclined plane and the parallelogram law of force synthesis. In 1586, he proposed the famous inclined plane law: the gravity along the inclined plane to which an object placed on the inclined plane is subject to is proportional to the sine of the inclination angle. The inclined plane refers to a smooth plane inclined to the horizontal plane. The helix is a deformation of the “inclined plane”. The thread is like an inclined plane wrapped around a cylinder. The smoother the inclined plane, the greater the mechanical benefit (refer to FIG. 7) (Yang Jingshan and Wang Xiuya, “Discussion on the Principle of Screws”, “Research on Gaussian Arithmetic”).

The “inclined surface principle” of modern threads is an inclined surface slider model based on the inclined surface law (refer to FIG. 8). It is believed that under the condition of small static load and temperature change, when the thread lead angle is less than or equal to the equivalent friction angle, the thread pairs have self-locking conditions. The thread lead angle (refer to FIG. 9) is also referred to as the thread angle of lead, which is the angle between the tangent of the spiral line on the pitch diameter cylinder and the plane perpendicular to the thread axis. This angle affects the self-locking and anti-loosening of the thread. The equivalent friction angle is the corresponding friction angle when different friction forms are finally transformed into the most common inclined slider form. Generally, in the inclined plane slider model, when the inclined plane is inclined to a certain angle, the friction force of the slider at this time is exactly equal to the component of gravity along the inclined plane. At this time, the object is just in the equilibrium state of force, and the inclined plane inclination angle at this time is referred to as the equivalent friction angle.

American engineers invented the wedge-shaped thread in the middle of the last century, and its technical principle still follows the “inclined plane principle.” The invention of the wedge-shaped thread was inspired by the “wood wedge”. Specifically, the structure of wedge-shaped thread is that there is a wedge-shaped inclined surface at the tooth root of the internal thread (i.e., a nut thread) of the triangular thread (commonly known as an ordinary thread), which forms an included angle of 25° to 30° with the thread axis. The actual engineering takes the wedge-shaped inclined surface of 30°. For a long time, people have researched and solved thread anti-loosening problems from the technical level and the technical direction of the thread profile angle. The wedge-shaped thread technology is no exception, and it is the specific application of the tapered wedge technology.

However, the existing threads have problems such as low connection strength, weak self-positioning ability, poor self-locking, low load-bearing value, poor stability, poor compatibility, poor reusability, high temperature and low temperature, etc. The typical problem is that bolts or nuts using modern thread technology have common defects of easy loosening. With frequent vibration or shocking of devices, bolts and nuts can loosen or even fall off, and even safety accidents are prone to occur.

### SUMMARY

Any technical theory has theoretical hypothesis background, and thread is no exception. With the advancement of science and technology, the damage to the connection is no longer a simple linear load, or static state, or room temperature environment. There are linear loads, non-linear loads or even the superposition of the linear loads and the non-linear loads, resulting in a more complex situation having damage to load, and the application conditions are complex. Based on this understanding, the object of the present invention is to solve the above problems and provide a connection structure having a bidirectional tapered external thread and a traditional thread with reasonable design, simple structure, good connection performance and locking property.

In order to achieve the above object, the present invention adopts the following technical solutions: the connection structure having a bidirectional tapered external thread and a traditional thread is used by a thread connection pair formed by an external thread of the asymmetric bidirectional tapered thread and an internal thread of the traditional thread. It is a special thread pair technology that combines the characteristics of the conical pair and the spiral movement. The external thread of the bidirectional tapered thread is a thread technology combining the technical characteristics of the bidirectional cone and the spiral structure. The bidirectional cone is formed by two single cones. It is formed bidirectionally by two single cones with the same direction of the left taper and the right taper, and the taper of the left tapered body is greater than the taper of the right tapered body. The external thread of the asymmetric bidirectional tapered thread is spirally distributed on the outer surface of the columnar body to form an external thread by the bidirectional tapered body. The complete unit body thread is a dumbbell-shaped special bidirectional tapered geometry having a small middle and two large ends in which the left taper is greater than the right taper.

For the bidirectional tapered external thread and the traditional thread, the external thread definition of the asymmetric bidirectional tapered thread can be expressed as: “a spiral dumbbell-shaped special bidirectional tapered geometry having a small middle and two large ends having asymmetric bidirectional truncated cones and being continuously and/or discontinuously distributed along the spiral line, in which the left taper and the right taper are prescribed, the left taper and the right taper have opposite directions, and the left taper is greater than the right taper.” Due to manufacturing reasons, the head and tail of an asymmetric bidirectional tapered thread may be incomplete bidirectional tapered geometry. Different from the modern thread technology, the thread technology has changed from the original enveloping relationship of the internal thread and the external thread of the modern thread to the enveloping relationship of the internal thread and the external thread of the bidirectional tapered thread.

The bidirectional tapered external thread and the traditional thread comprise an external thread and an internal thread which are in screw-thread fit with each other, the external thread is a bidirectional truncated cone spirally distributed on the outer surface of the columnar body, the internal thread is a special tapered hole spirally distributed on the inner surface of the cylindrical body, that is, the internal thread distributes a spiral special tapered hole and exists in the form of “non-solid space”, and the external thread distributes a spiral bidirectional truncated cone and exists in the form of a “material entity”. The non-solid space refers to the space environment that can accommodate the material entity. The internal thread is the containing part, and the external thread is the contained part: the internal thread and the external thread are bidirectional tapered geometries that are screwed and sleeved together until one side bears in both directions or the left and right sides bear in both directions simultaneously or until the size is interference fit. Whether the two sides bear in both directions simultaneously depends on the actual working conditions of the application, that is, the traditional internal thread contains and envelops the bidirectional truncated cone of the bidirectional tapered external thread in sections due to the special tapered hole formed by being in contact with the bidirectional tapered external thread, that is, the internal thread is corresponding to the external thread by envelopment in sections.

The thread connection pair is a conical pair formed by a spiral outer conical surface and a spiral inner conical surface that cooperate to form a thread pair. The outer conical surface of the outer cone is a bidirectional conical surface. When the bidirectional tapered external thread and the traditional internal thread form a thread connection pair, the joint surface of the special conical surface of the traditional internal thread and the outer conical surface of the bidirectional tapered external thread is used as the supporting surface, that is, the conical surface is used as the supporting surface to realize the connection technical performance. The self-locking property, self-positioning property, reusability and fatigue resistance of the thread pair mainly depend on the conical surface and the taper size of the truncated cone of the bidirectional tapered external thread forming the bidirectional tapered external thread and the traditional thread and the special conical surface and the taper size of the special tapered hole formed in such a manner that the internal thread of the traditional thread is in contact with the bidirectional tapered external thread. The thread is a non-tooth thread.

Different from the unidirectional force distributed on the inclined plane and the meshing relationship of the internal and external threads between the internal tooth and the external tooth, which is shown by the existing thread inclined plane principle, for the bidirectional tapered external thread and the traditional thread, no matter whether the external thread (that is, the bidirectional tapered body) is distributed on the left or right side, the single tapered body is bidirectionally formed by two element lines of the cone through the conical axis section, and is in the bidirectional state. The element line is the intersection of the conical surface and the plane passing through the conical axis. The conical principle of the connection structure of the bidirectional tapered external thread and the traditional thread shows the axial force and the anti-axial force, both of which are combined by the bidirectional force. The axial force and the corresponding anti-axial force are opposite. The internal thread and the external thread are in an enveloping relationship, that is, the thread pair is formed by the internal thread envelops the external thread, that is, sections of tapered holes (the inner cone) envelops the corresponding section of cones (the outer cone) until the enveloping size cooperates to realize self-positioning or until the size realizes interference contact to realize self-locking, that is, the special tapered hole and the truncated cone radially envelop together so that the inner cone and the outer cone are self-locked or self-positioned to realize the self-locking or self-positioning of the thread pair, rather than the internal thread and the external thread of the traditional thread forming a thread connection pair, which realizes the threaded connection performance through the mutual abutment between the teeth.

There will be a self-locking force when the internal thread and the external thread meet certain conditions during the enveloping process. The self-locking force is generated by the intensity of pressure generated between the axial force of the inner cone and the anti-axial force of the outer cone, that is, when the inner cone and the outer cone form a conical pair, the inner conical surface of the inner cone envelops the outer conical surface of the outer cone, and the inner conical surface is in close contact with the outer conical surface. The axial force of the inner cone and the anti-axial force of the outer cone are the unique force concept of the bidirectional tapered thread technology of the present invention, that is, the conical pair technology.

The inner cone exists in a form similar to a shaft sleeve. Under the action of external load, the inner cone generates an axial force pointing to or pressing against the conical axis. The axial force combined in both directions by a pair of centripetal forces which are distributed in an mirror image centered on the conical axis and are perpendicular to the two element lines of the cone, that is, the axial force passing through the conical axis section is formed by two centripetal forces which are distributed on both sides of the conical axis in both directions in an mirror image centered on the conical axis, are perpendicular to the two element lines of the cone, and point to or press against the common point of the conical axis. When the cone and the spiral structure are combined into a thread and applied to the thread pair, the axial force passing through the thread axis section is formed by two centripetal forces which are distributed on both sides of the thread axis in both directions in an mirror image and/or an approximate mirror image centered on the thread axis, are perpendicular to the two element lines of the cone, and point to or press against the common point and/or the approximately common point of the thread axis. The axial force is densely distributed on the conical axis and/or the thread axis in an axial and circumferential manner. The axial force corresponds to an axial force angle. The included angle of the two centripetal forces forming the axial force constitutes the axial force angle, and the magnitude of the axial force angle depends on the taper size of the cone, that is, the size of the taper angle.

The outer cone exists in a form of a similar shaft and has a strong ability to absorb various external loads. The outer cone generates an anti-axial force opposite each axial force of the inner cone. The anti-axial force combined in both directions by a pair of anti-centripetal forces which are distributed in an mirror image centered on the conical axis and are perpendicular to the two element lines of the cone, that is, the anti-axial force passing through the conical axis section is formed by two anti-centripetal forces which are distributed on both sides of the conical axis in both directions in an mirror image centered on the conical axis, are perpendicular to the two element lines of the cone, and point to or press against the inner conical surface from the common point of the conical axis. When the cone and the spiral structure are combined into a thread and applied to the thread pair, the anti-axial force passing through the thread axis section is formed by two anti-centripetal forces which are distributed on both sides of the thread axis in both directions in an mirror image and/or an approximate mirror image centered on the thread axis, are perpendicular to the two element lines of the cone, and point to or press against the conical surface of the internal thread from the common point and/or the approximately common point of the thread axis. The anti-axial force is densely distributed on the conical axis and/or the thread axis in an axial and circumferential manner. The anti-axial force corresponds to an anti-axial force angle. The included angle of the two anti-centripetal forces forming the anti-axial force constitutes the anti-axial force angle, and the magnitude of the anti-axial force angle depends on the taper size of the cone, that is, the size of the taper angle.

The axial force and anti-axial force begin to be generated when the inner and outer cones of the conical pair are in effective contact, that is, a pair of corresponding and opposite axial force and anti-axial force always exists during the effective contact process of the inner cone and the outer cone of the conical pair. The axial force and anti-axial force are both bidirectional forces centered on the conical axis and/or the thread axis and distributed in both directions in a mirror image instead of unidirectional forces. The conical axis and the thread axis are the coincidence axis, that is, the same axis and/or approximately the same axis. The anti-axial force and the axial force are oppositely collinear, and when the cone and the spiral structure are combined into threads and form a thread pair, they are oppositely collinear and/or approximately oppositely collinear. The inner cone and the outer cone are enveloped until the interference, and the axial force and anti-axial force generate intensity of pressure at the contact surface of the inner conical surface and the outer conical surface, and are densely distributed axially and evenly at the contact surface of the inner and outer conical surfaces in the circumferential direction. When the enveloping movement of the inner cone and the outer cone continues until the conical pair reaches the intensity of pressure generated by the interference fit, and the inner cone and the outer cone are combined, that is, the intensity of pressure causes the inner cone to envelop the outer cone to form a similar overall structure. After the external force resulted therefrom disappears, the inner cone and the outer cone will not be separated from each other under the action of gravity due to the arbitrary change of the position direction of the similar overall structure. The conical pair will be self-locked, that is, the thread pair will be self-locked. The self-locking property also has a certain limit of resistance to other external loads that may cause the inner cone to be separated from the outer cone in addition to gravity. The conical pair also has the self-positioning property that the inner cone and the outer cone cooperate with each other, but not any axial force angle and/or anti-axial force angle can cause the conical pair to be self-locked and self-positioned.

When the axial force angle and/or the anti-axial force angle are less than 180° and greater than 127°, the conical pair is self-locking. When the axial force angle and/or the anti-axial force angle are infinitely close to 180°, the self-locking property is the best, and its axial bearing capacity is the weakest. When the axial force angle and/or the anti-axial force angle are equal to and/or less than 127° and greater than 0°, the conical pair is in the interval of having weak self-locking and/or no self-locking. When the axial force angle and/or the anti-axial force angle tend to change infinitely close to 0°, the self-locking property of the conical pair will change in a decreasing trend until it has no self-locking ability at all. The axial bearing capacity change in an increasing trend until the axial bearing capacity is the strongest.

When the axial force angle and/or the anti-axial force angle is less than 180° and greater than 127°, the conical pair is in a strong self-positioning state, and it is easy for the inner and outer cones to achieve strong self-positioning. When the axial force angle and/or the anti-axial force angle are infinitely close to 180°, the inner and outer cones of the conical pair have the strongest self-positioning ability. When the axial force angle and/or the anti-axial force angle are equal to and/or less than 127° and greater than 0°, the conical pair is in a weak self-positioning state. When the axial force angle and/or the anti-axial force angle tend to change infinitely close to 0°, the mutual self-positioning ability of the inner and outer cones of the conical pair will change in a decreasing trend until it nearly completely has no self-positioning ability.

Compared with the containing and contained relationship of the irreversibility unilateral bidirectional containment that the unidirectional tapered thread of the single tapered body invented by the applicant before can only bear at a single side of the conical surface, for the bidirectional thread connection pair, the reversibility bidirectional containment of the bidirectional tapered thread of the bidirectional tapered body at the left and right sides causes the left side of the conical surface to bear and/or the right side of the conical surface to bear and/or the left side conical surface and the right side conical surface to bear respectively and/or the left side conical surface and the right side conical surface to bear in both directions at the same time, which further restricts the disordered degree of freedom between the special tapered hole and the truncated cone. The spiral movement allows the connection structure of the bidirectional tapered external thread and the traditional thread to obtain the necessary orderly degree of freedom, effectively combining the technical characteristics of the conical pair and the thread pair to form a new thread technology.

In the use of the connection structure of the bidirectional tapered external thread and the traditional thread, the conical surface of the bidirectional truncated cone of the external thread of the bidirectional conical thread is matched with the special conical surface of the special tapered hole of the traditional internal thread.

For the bidirectional tapered external thread and the traditional thread, the bidirectional tapered external thread, namely the truncated cone, does not have any taper or any taper angle which can realize the self-locking and/or self-positioning of the thread connection pair. The outer cone must reach a certain taper or a certain taper angle. The connection structure of the bidirectional tapered external thread and the traditional thread can have self-locking and self-positioning properties. The taper comprises the left taper and the right taper of the external threads. The taper angle comprises the left taper angle and the right taper angle of the external threads. The left taper corresponds to the left taper angle, that is, the first taper angle α1, preferably, the first taper angle α1 is greater than 0° and less than 53°, preferably, the first taper angle α1 takes a value of 2°-40°. In individual special fields, preferably, the first taper angle α1 is greater than or equal to 53° and less than 180°, preferably, the first taper angle α1 takes a value of 53°-90°; the right taper corresponds to the right taper angle, that is, the second taper angle α2, preferably, the second taper angle α2 is greater than 0° and less than 53°, preferably, the second taper angle α2 takes a value of 2°-40°.

The individual special fields refer to the threaded connection application fields where self-locking is required to be low or even self-locking is not required and/or self-positioning is required to be weak and/or axial bearing capacity is required to be high and/or transmission connection must be provided with anti-locking measures, etc.

For the bidirectional tapered external thread and the traditional thread, the external thread is provided on the outer surface of the columnar body, wherein the columnar body has a screw. The truncated cone is spirally distributed on the outer surface of the screw. The truncated cone comprises a bidirectional truncated cone. The columnar body can be solid or hollow, comprising workpieces and objects such as a cylinder and/or non-cylinder that need to process the thread on the outer surface. The outer surface comprises the outer surface geometrical shape such as a cylindrical surface or a non-cylindrical surface such as a conical surface.

For the bidirectional tapered external thread and the traditional thread, the bidirectional truncated cone, that is, the external thread, is a thread formed in a spiral shape in which two truncated cones with the same lower bottom surfaces and the same upper top surfaces but different cone heights have symmetrical upper top surfaces which are mutually oppositely joined and lower bottom surfaces which are located at both ends of the bidirectional truncated cone and are mutually joined with the lower bottom surface of the adjacent bidirectional truncated cone and/or are mutually joined with the lower bottom surface of the adjacent bidirectional truncated cone when forming a dumbbell-shaped asymmetrical bidirectional tapered thread. The external threads comprise a first spiral conical surface of the truncated cone and a second spiral conical surface of the truncated cone and the outer spiral line. In the section passing through the thread axis, the whole single-section asymmetric bidirectional tapered external thread is a dumbbell-shaped special bidirectional tapered geometry having a small middle and two large ends, and the left taper is greater than the right tape. The bidirectional truncated cone comprises the conical surface of a bidirectional truncated cone. The included angle between two element lines of the conical surface of the left side, namely the first spiral conical surface of the truncated cone, is the first taper angle α1. The first spiral conical surface of the truncated cone forms the left taper and is distributed in the right direction. The included angle between two element lines of the conical surface of the right side, namely the second spiral conical surface of the truncated cone, is the second taper angle α2. The second spiral conical surface of the truncated cone forms the right taper and is distributed in the left direction. The first taper angle α1 and the second taper angle α2 correspond to the opposite taper direction. The element line is the intersection of the conical surface and the plane passing through the conical axis. The shape formed by the first spiral conical surface of the truncated cone and the second spiral conical surface of the truncated cone of the bidirectional truncated cone is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

The bidirectional tapered external thread has a strong ability to assimilate different kinds of threads because of its unique technical characteristics and advantages that the thread body is a tapered body, that is, a truncated cone. The bidirectional tapered external thread has the ability to assimilate the traditional thread that is matched to become a special form of tapered thread with the same technical characteristics and properties. The traditional thread assimilated by the tapered thread, that is, the alienated traditional thread, seems that the shape of the thread body is not much different from the traditional thread tooth, but it does not have the substantive technical content of the threaded body of the traditional thread. The threaded body has changed from the original traditional threaded tooth nature to the special tapered geometry with the thread nature of the tapered thread, that is, the tapered body nature and technical characteristics. The special tapered geometry has a special conical surface that is capable of radially matching the spiral conical surface of the tapered thread. The traditional thread comprises triangular threads, trapezoidal threads, sawtooth threads, rectangular threads, circular arc threads, etc., and other geometric forms of threads which can be screwed with the bidirectional tapered threads to form a thread connection pair, but is not limited to the above threads.

When the traditional internal thread and the bidirectional tapered external thread cooperate to form a thread connection pair, the traditional internal thread at this time is not a traditional thread in the original sense, but a special form of tapered thread that is assimilated by the tapered thread. The contact part with the bidirectional tapered external thread forms the inner surface of the special tapered hole of the traditional internal thread of the thread connection pair that can match the spiral conical surface of the tapered thread, that is, a special conical surface on the special tapered hole. With the increase in the number of screwing and using, the effective conical surface area of the special conical surface on the special tapered hole of the traditional internal thread will continue to increase, that is, the special conical surface will continue to increase and tend to have a greater change in the direction of the contact surface with the conical surface of the truncated cone of the bidirectional tapered external threaded, essentially forming a special tapered hole that has the technical spirit of the present invention although the tapered geometry is incomplete. Furthermore, the special tapered hole is a threaded body formed in such a manner that the traditional internal threaded is assimilated due to being in enveloping contact with the bidirectional tapered external thread, and is a special tapered geometric body transformed from the traditional internal thread tooth. The special tapered hole has an inner surface that can match the conical surface of the bidirectional truncated cone in the radial direction. That is, the thread connection pair is a cone pair formed in such a manner that the special tapered hole and the special conical surface formed since the spiral outer conical surface, that is, an outer conical surface of the bidirectional conical external thread, and a spiral special conical surface, that is, the traditional internal thread, are in contact with the bidirectional tapered external thread cooperate with each other, so as to form a thread pair. The outer conical surface, that is, the outer conical surface of the outer cone which is the truncated cone, is a bidirectional conical surface. The traditional thread after being assimilated is an alienated traditional thread, and a special form of tapered thread. The inner conical surface of this special form of tapered thread, that is, the special conical surface of the traditional internal thread, first appears in the form of a line, and the internal conical surface gradually increases while the number of times of contact between the traditional internal thread tooth tip and the bidirectional tapered external thread truncated cone increases. That is, the special conical surface of the traditional internal thread continues to change and increase from a microscopic surface (a line in a macroscopic sense) to a macroscopic surface. It is also possible to directly process the inner conical surface matching the bidirectional tapered external thread on the tooth tip of the traditional internal thread, which complies with the technical spirit of the present invention.

For the bidirectional tapered external thread and the traditional thread, the internal thread is provided on the inner surface of the cylindrical body to form a nut, wherein the cylindrical body has a nut. The special tapered holes are spirally distributed on the inner surface of the nut. The special tapered hole refers to a special tapered hole formed due to contacting the traditional internal thread with the bidirectional tapered external thread, and the special tapered hole is provided with a special conical surface. The cylindrical body comprises workpieces and objects such as a cylinder and/or non-cylinder that need to process the internal thread on the inner surface. The inner surface comprises inner surface geometric shapes such as a cylindrical surface or a non-cylindrical surface such as a conical surface.

When the connection structure having the bidirectional tapered external thread and the traditional thread works, the relationship with the workpiece comprises rigid connection and non-rigid connection. The rigid connection means that the nut supporting surface and the workpiece supporting surface are mutually supporting surfaces, comprising the structural form such as a single nut and double nuts. The non-rigid connection means that the opposite side end surfaces of the two nuts are mutually supporting surfaces and/or washers between the opposite side end faces of two nuts are indirectly mutually supporting surfaces. It is mainly used in non-rigid materials or non-rigid connection workpieces such as transmission parts, or application fields in which installation is achieved by double nuts to meet requirements. The workpiece refers to the connected object comprising the workpiece, and the washer refers to the spacer comprising the washer.

When the bidirectional tapered external thread and the traditional thread adopt the connection structure of the bidirectional tapered threaded bolt and the traditional thread double-nut and the relationship with the fastened workpiece is rigid connection, the threaded working supporting surfaces, that is, the conical supporting surfaces, are different. When the cylindrical body is located on the left side of the fastened workpiece, that is, when the left end surface of the fastened workpiece and the right end surface of the cylindrical body, that is, the left nut, are the locking supporting surface of the left nut and the fastened workpiece, the columnar body, that is, the screw, that is, the spiral conical surface of the left side of the bidirectional tapered thread of the bolt, is the tapered threaded supporting surface. The special conical surface of the traditional internal thread and the first spiral conical surface of the truncated cone of the bidirectional tapered external thread are the tapered thread supporting surfaces, and the special conical surface of the traditional internal thread and the first spiral conical surface of the truncated cone are the mutually supporting surfaces. When the cylindrical body is located on the right side of the fastened workpiece, that is, when the right end surface of the fastened workpiece and the left end surface of the cylindrical body, that is, the right nut, are the locking supporting surface of the right nut and the fastened workpiece, the cylindrical body, that is, the screw, that is, the spiral conical surface of the right side of the bidirectional tapered thread of the bolt, is the tapered threaded supporting surface. The special conical surface of the traditional internal thread and the first spiral conical surface of the truncated cone of the bidirectional tapered external thread are the tapered thread supporting surfaces, and the special conical surface of the traditional internal thread and the second spiral conical surface of the truncated cone are the mutually supporting surfaces.

When the bidirectional tapered external thread and the traditional thread adopt the connection structure of the bidirectional tapered threaded bolt and the traditional thread single-nut and the relationship with the fastened workpiece is rigid connection, when the hexagon head of the bolt is on the left side, the cylindrical body, that is the nut, that is, the single nut, is located on the right side of the fastened workpiece. When the bolt-single nut connection structure works, the right end surface of the workpiece and the left end surface of the nut are the locking supporting surfaces of the nut and the fastened workpiece. The columnar body, that is, the screw, that is, the spiral conical surface of the right side of the bidirectional tapered thread of the bolt, is the tapered thread supporting surface. The special conical surface of the traditional internal thread and the second spiral conical surface of the truncated cone of the bidirectional tapered external thread are the tapered thread supporting surfaces, and the special conical surface of the traditional internal thread and the second spiral conical surface of the truncated cone are the mutually supporting surfaces; when the hexagon head of the bolt is on the right side, the columnar body, that is the nut, that is, the single nut, is located on the left side of the fastened workpiece. When the bolt-single nut connection structure works, the left end surface of the workpiece and the right end surface of the nut are the locking supporting surfaces of the nut and the fastened workpiece. The columnar body, that is, the screw, that is, the spiral conical surface of the left side of the bidirectional tapered thread of the bolt, is the tapered threaded supporting surface. The special conical surface of the traditional internal thread and the first spiral conical surface of the truncated cone of the bidirectional tapered external thread are the tapered thread supporting surfaces, and the special conical surface of the traditional internal thread and the first spiral conical surface of the truncated cone are the mutually supporting surfaces.

When the bidirectional tapered external thread and the traditional thread adopt the connection structure of the bidirectional tapered threaded bolt and the traditional thread double-nut and the relationship with the fastened workpiece is non-rigid connection, the threaded working supporting surfaces, that is, the tapered threaded supporting surfaces, are different. The cylindrical body comprises a left nut and a right nut. The right end surface of the left nut and the left end surface of the right nut are in direct contact with each other oppositely and are mutually locking supporting surfaces. When the right end surface of the left nut is a locking support supporting surface, the columnar body, that is, the screw, that is, the spiral conical surface of the left side of the bidirectional tapered thread of the bolt, is the tapered threaded supporting surface. The special conical surface of the traditional internal thread and the first spiral conical surface of the truncated cone of the bidirectional tapered external thread are the tapered thread supporting surfaces, and the special conical surface of the traditional internal thread and the first spiral conical surface of the truncated cone are the mutually supporting surfaces. When the left end surface of the right nut is a locking support supporting surface, the columnar body, that is, the screw, that is, the spiral conical surface of the right side of the bidirectional tapered thread of the bolt, is the tapered threaded supporting surface. The special conical surface of the traditional internal thread and the second spiral conical surface of the truncated cone of the bidirectional tapered external thread are the tapered thread supporting surfaces, and the special conical surface of the traditional internal thread and the second spiral conical surface of the truncated cone are the mutually supporting surfaces.

When the bidirectional tapered external thread and the traditional thread adopt the connection structure of the bidirectional tapered threaded bolt and the traditional thread double-nut and the relationship with the fastened workpiece is non-rigid connection, the tapered threaded supporting surfaces are different. The cylindrical body comprises a left nut and a right nut, and there are spacers such as washers between the two cylindrical bodies, namely the left nut and the right nut. The right end surface of the left nut and the left end surface of the right nut are in indirect contact with each other oppositely through the washer, thereby indirectly acting as a mutually locking supporting surface. When the cylindrical body is on the left side of the washer, that is, when the left side surface of the washer and the right side end surface of the left nut are the locking supporting surface of the left nut, the cylindrical body, that is, the screw, that is, the spiral conical surface of the left side of the bidirectional tapered thread of the bolt, is the tapered threaded supporting surface. The special conical surface of the traditional internal thread and the first spiral conical surface of the truncated cone of the bidirectional tapered external thread are the tapered thread supporting surfaces, and the special conical surface of the traditional internal thread and the first spiral conical surface of the truncated cone are the mutually supporting surfaces. When the cylindrical body is on the right side of the washer, that is, when the right side surface of the washer and the left side end surface of the right nut are the locking supporting surface of the right nut, the columnar body, that is, the screw, that is, the spiral conical surface of the right side of the bidirectional tapered thread of the bolt, is the tapered threaded supporting surface. The special conical surface of the traditional internal thread and the second spiral conical surface of the truncated cone of the bidirectional tapered external thread are the tapered thread supporting surfaces, and the special conical surface of the traditional internal thread and the second spiral conical surface of the truncated cone are the mutually supporting surfaces.

Further, when the cylindrical body on the inner side, that is, the nut adjacent to the fastened workpiece, is effectively combined with the columnar body, that is, the screw, that is, the bolt, the internal thread and the external thread forming the thread connection pair are effectively enveloped together. The cylindrical body on the outer side, that is, the nut that is not adjacent to the fastened workpiece, needs to remain intact and/or be disassembled, leaving only one nut according to the application working conditions (for example, the application fields that require lightweight devices or do not require double nuts to ensure the reliability of the connection technology). The removed nut is not used as a connecting nut, but is only used as an installation process nut. The internal thread of the installation process nut is not only made of traditional threads, comprising triangular threads, trapezoidal thread, sawtooth threads, etc., but are not limited to the above threads, and can be applied where appropriate, but also can be a nut body manufactured by adopting bidirectional tapered threads and unidirectional tapered threads which can be screwed with bolt threads. On the premise of ensuring the reliability of the connection technology, the thread connection pair is a closed-loop fastening technology system, that is, after the internal thread and the external thread of the thread connection pair are effectively enveloped together, the thread connection pair will become an independent technical system without relying on the technical compensation of the third party to ensure the technical validity of the connection technology system. Even if there is no support from other objects, the gap between the thread connection pair and the fastened workpiece will not affect the effectiveness of the thread connection pair. This will help greatly reduce the weight of the device, remove the ineffective load, and improve the technical requirements such as the effective load capacity, braking property, and energy conservation and emission reduction of the device. This is the advantage of thread technology that is unique no matter when the relationship between the connection structure having the bidirectional tapered external thread and the traditional thread and the fastened workpiece is non-rigid connection or rigid connection, and that other thread technologies do not have.

When the bidirectional tapered external thread and the traditional thread are connected in transmission, the special tapered hole of the traditional internal thread is screwed and connected to the bidirectional truncated cone, which bears in both directions. When the external thread and the internal thread form a thread pair, there must be a clearance between the bidirectional truncated cone and the special tapered hole of the traditional internal thread. If there is oil and other media lubrication between the internal thread and the external thread, it will easily form a bearing oil film. The clearance is conducive to the formation of the bearing oil film. The bidirectional tapered external thread and the traditional thread are used in transmission connection, which is equivalent to a set of sliding bearing pairs formed by one pair and/or several pairs of sliding bearings, that is, each section of traditional internal thread bidirectionally contains a corresponding section of bidirectional tapered external thread to form a pair of sliding bearings. The number of the formed sliding bearings is adjusted according to the application conditions, that is, the number of the containing and contained threaded section of the effective bidirectional engagement of the traditional internal thread and the bidirectional tapered external thread, which is the effective bidirectional contact envelopment, is designed according to the application conditions. The special tapered hole of the traditional internal thread bidirectionally contains the truncated cone of the tapered external thread and is positioned in multiple directions such as in radial, axial, angular, and circumferential directions. Preferably, the special tapered hole contains the bidirectional truncated cone and is mainly positioned in radial and circumferential directions, and is supplementarily positioned in axial and angular directions so as to form the multi-directional positioning of the inner and outer cones until the special conical surface of the special tapered hole and the conical surface of the bidirectional truncated cone are enveloped to achieve self-positioning or until the size realizes interference contact to realize self-locking. A special combining technology of the conical pair and the thread pair is formed to ensure the accuracy, efficiency and reliability of transmission connection of the tapered thread technology, especially the bidirectional tapered external thread and the traditional thread.

When the bidirectional tapered external thread and the traditional thread are connected in a fastened and sealed manner, its technical performance is realized by the screw connection of the special tapered hole of the traditional internal thread and the bidirectional truncated cone of the tapered external thread, that is, the first spiral conical surface of the truncated cone and the special conical surface of the special tapered hole of the traditional internal thread are sized until the interference is achieved, and/or the second spiral conical surface of the truncated cone and the special conical surface of the special tapered hole of the traditional internal thread are sized until the interference is achieved. According to the application conditions, bearing is achieved in one direction and/or in two directions simultaneously. That is, the bidirectional truncated cone and the special tapered hole of the traditional internal thread are guided by the spiral line, and the inner and outer diameters of the inner cone of the special tapered hole of the traditional internal thread and the outer cone of the tapered external thread are centered until the special conical surface of the special tapered hole of the traditional internal thread and the first spiral conical surface of the truncated cone are enveloped until the interference contact is achieved, and/or the special conical surface of the special tapered hole of the traditional internal thread and the second spiral conical surface of the truncated cone are enveloped until the interference contact is achieved. The special tapered hole of the traditional internal thread contains the self-locking of the bidirectional truncated cone of the tapered external thread and is positioned in multiple directions such as in radial, axial, angular, and circumferential directions. Preferably, the special tapered hole contains the bidirectional truncated cone and is mainly positioned in radial and circumferential directions, and is supplementarily positioned in axial and angular directions so as to form the multi-directional positioning of the inner and outer cones until the conical surface of the bidirectional tapered hole and the conical surface of the bidirectional truncated cone are enveloped to achieve self-positioning or until the size realizes interference contact to realize self-locking. A special combining technology of the conical pair and the thread pair ensures the efficiency and reliability of the tapered thread technology, especially the connection structure having the bidirectional tapered external thread and the traditional thread, so as to realize the technical performance of mechanical mechanism connection, locking, anti-loosening, bearing, fatigue and sealing.

Therefore, for the connection structure having the bidirectional tapered external thread and the traditional thread, the technical performance of the mechanical structure, such as the transmission accuracy and efficiency, the bearing capacity, the self-locking force, the anti-loosening capacity, and the sealing property, is related to the first spiral conical surface of the truncated cone and the formed left taper, that is, the corresponding first taper angle α1, and the second spiral conical surface of the truncated cone and the formed right taper, that is, the corresponding second taper angle α2, and is also related to the special conical surface of the traditional internal thread and the taper formed by contacting the traditional internal thread and the bidirectional tapered external thread. The material friction coefficient, processing quality and application conditions of the columnar body and the cylindrical body also have a certain influence on the cooperation of the cone.

In the bidirectional tapered external thread and the traditional thread, when the right-angled trapezoid combination rotates at a uniform speed for a circle, the axial movement distance of the right-angled trapezoidal combination is at least twice the length of the sum of the right-angle sides of the two right-angled trapezoids with the same lower bottom lines and the same upper bottom lines but different right-angled sides. This structure ensures that the first spiral conical surface of the truncated cone and the second spiral conical surface of the truncated cone have sufficient length, thereby ensuring that when the conical surface of the bidirectional truncated cone is matched with the special conical surface of the special tapered hole of the traditional internal thread, it has sufficient effective contact area and strength as well as the efficiency required for spiral movement.

In the bidirectional tapered external thread and the traditional thread, when the right-angled trapezoid combination rotates at a uniform speed for a circle, the axial movement distance of the right-angled trapezoidal combination is equal to the length of the sum of the right-angle sides of the two right-angled trapezoids with the same lower bottom lines and the same upper bottom lines but different right-angled sides. This structure ensures that the first spiral conical surface of the truncated cone and the second spiral conical surface of the truncated cone have sufficient length, thereby ensuring that when the conical surface of the bidirectional truncated cone is matched with the special conical surface of the special tapered hole of the traditional internal thread, it has sufficient effective contact area and strength as well as the efficiency required for spiral movement.

In the bidirectional tapered external thread and the traditional thread, the first spiral conical surface of the truncated cone and the second spiral conical surface of the truncated cone are both continuous spiral surfaces or discontinuous spiral surfaces.

In the bidirectional tapered external thread and the traditional thread, the special conical surface of the special tapered hole is a continuous spiral surface or a discontinuous spiral surface.

In the bidirectional tapered external thread and the traditional thread, one end and/or both ends of the columnar body can be screwed into the screwing end of the connecting hole of the cylindrical body. The thread connection function is realized through the contact and/or interference fit between the special conical surface of the traditional internal thread and the first spiral conical surface of the tapered external thread truncated cone and/or the contact and/or interference fit between the special conical surface of the traditional internal thread and the second spiral conical surface of the tapered external thread truncated cone.

In the bidirectional tapered external thread and the traditional thread, one end of the columnar body is provided with a head having a size larger than the outer diameter of the columnar body and/or one end and/or both ends of the columnar body are provided with a head smaller than the small diameter of the bidirectional tapered external thread of the columnar body screw. The connecting hole is a threaded hole provided on the nut. That is, the columnar body herein connected to the head is a bolt. The columnar body having no head and/or having the heads at both ends smaller than the small diameter of the bidirectional tapered external thread and/or having no thread in the middle but having bidirectional tapered external threads at both ends is a bolt. The connecting hole is provided in the nut.

Compared with the prior art, the advantages of the connection structure having the bidirectional tapered external thread and the traditional thread are as follows: the design is reasonable, the structure is simple, the conical pair formed by centering the coaxial inner and outer diameters of the inner and outer cones bears or is sized in both directions until there is interference fit to realize the function of fastening and connection, it is convenient to operate, the locking force is large, the bearing value is large, the anti-loose performance is good, the transmission efficiency and the precision are high, the mechanical sealing effect is good, the stability is good, the loosening phenomenon can be prevented during connection, and there are self-locking and self-positioning functions.

### BRIEF DESCRIPTION OF THE DRAWINGS

FIG. 1 is a schematic diagram of a connection pair structure having a dumbbell-shaped (the left taper is greater than the right taper) asymmetric bidirectional tapered external thread and a traditional thread according to Embodiment 1 of the present invention.

FIG. 2 is a schematic diagram of a threaded structure of a dumbbell-shaped (the left taper is greater than the right taper) asymmetric bidirectional tapered external thread and a complete unit according to Embodiment 1 of the present invention.

FIG. 3 is a schematic diagram of a connection pair structure having a dumbbell-shaped (the left taper is greater than the right taper) asymmetric bidirectional tapered threaded bolt and double nuts of a traditional thread according to Embodiment 2 of the present invention.

FIG. 4 is a schematic diagram of a connection pair structure having a dumbbell-shaped (the left taper is greater than the right taper) asymmetric bidirectional tapered bolt and a single nut of a traditional thread according to Embodiment 3 of the present invention.

FIG. 5 is a schematic diagram of a connection structure having a dumbbell-shaped (the left taper is greater than the right taper) asymmetric bidirectional tapered threaded bolt and double nuts of a traditional thread according to Embodiment 4 of the present invention.

FIG. 6 is a schematic diagram of a connection structure having a dumbbell-shaped (the left taper is greater than the right taper) asymmetric bidirectional tapered bolt and double nuts of a traditional thread (with a washer in the middle) according to Embodiment 5 of the present invention.

FIG. 7 is an illustration of “the thread of the existing thread technology being an inclined surface on a cylindrical or conical surface” involved in the background of the present invention.

FIG. 8 is an illustration of the “the inclined plane slider model of the principle of the existing thread technology—the inclined plane principle” involved in the background of the present invention.

FIG. 9 is an illustration of the “the thread lead angle of the existing thread technology” involved in the background of the present invention.

In the figures, tapered thread 1, cylindrical body 2, nut 21, nut 22, columnar body 3, screw 31, special tapered hole 4, special conical surface 42, internal thread 6, truncated cone 7, bidirectional truncated cone 71, conical surface of bidirectional truncated cone 72, first spiral conical surface of truncated cone 721, first taper angle α1, second spiral conical surface of truncated cone 722, second taper angle α2, external spiral line 8, external thread 9, dumbbell-shaped 94, left taper 95, right taper 96, left distribution 97, right distribution 98, thread connection pair and/or thread pair 10, clearance 101, locking supporting surface 111, locking supporting surface 112, tapered thread supporting surface 122, tapered thread supporting surface 121, workpiece 130, nut locking direction 131, washer 132, conical axis 01, thread axis 02, slider on inclined surface A, inclined surface B, gravity G, component of gravity along inclined surface G1, friction F, thread lead angle φ, equivalent friction angle P, traditional external thread major diameter d, traditional external thread minor diameter d1, traditional external thread middle diameter d2.

### DESCRIPTION OF THE EMBODIMENTS

The present invention will be further described in detail below with reference to the drawings and specific embodiments.

### Embodiment 1

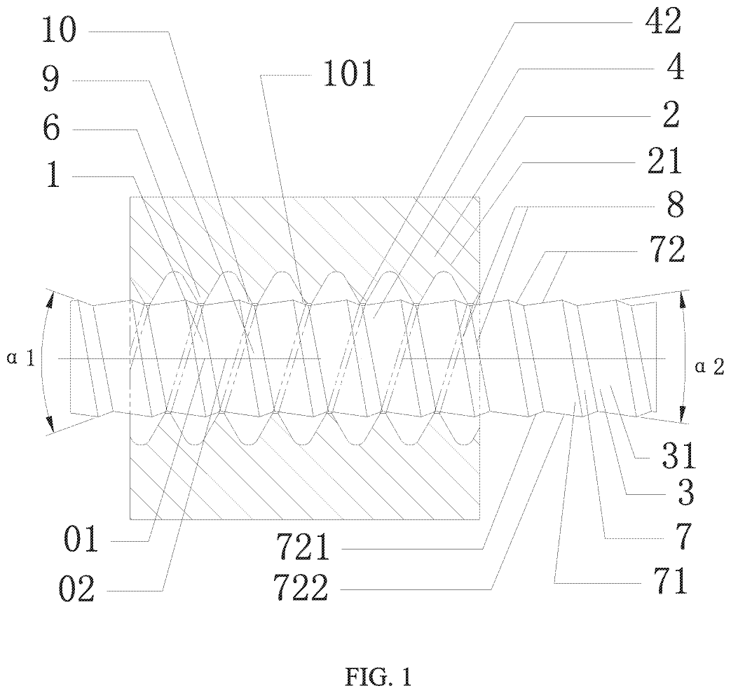

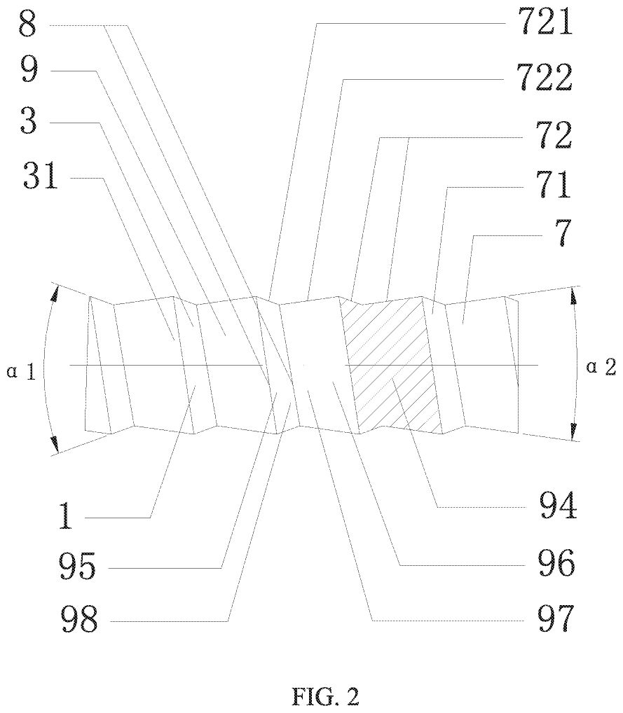

As shown in FIG. 1 and FIG. 2, the present embodiment adopts a connection structure having an asymmetric bidirectional tapered external thread 9 and a traditional internal thread 6. The bidirectional tapered external thread and traditional thread connection pair 10 comprises a bidirectional truncated cone 71 spirally distributed on the outer surface of the columnar body 3 and a special tapered hole 4 formed by contacting the traditional internal thread 6 with the bidirectional tapered external thread 9 and spirally distributed on the inner surface of the cylindrical body 2, that is, comprising an external thread 9 and an internal thread 6 that are threaded with each other. The internal thread 6 distributes a spiral special tapered hole 4 and exists in the form of “non-solid space”, and the external thread 9 distributes a spiral bidirectional truncated cone 71 and exists in the form of a “material entity”. The internal thread 6 and the external thread 9 form the relationship of the containing part and the contained part: the internal thread 6 and the external thread 9 are screwed and sleeved together until interference fit is achieved. That is, the special tapered hole 4 formed by contacting the traditional internal thread 6 with the bidirectional tapered external thread 9 contains the bidirectional truncated cone 71 in sections. That is, the internal thread 6 contains the external thread 9 in sections. The bidirectional containment restricts the disordered degree of freedom between the special tapered hole 4 of the traditional internal thread 6 and the truncated cone 7. The spiral movement allows the bidirectional tapered external thread and traditional thread connection pair 10 to obtain the necessary orderly degree of freedom, effectively combining the technical characteristics of the conical pair and the thread pair.

When the bidirectional tapered external thread and traditional thread connection pair 10 is used in this embodiment, the conical surface 72 of a bidirectional truncated cone is matched with the special conical surface 42 of the special tapered hole 4 of the traditional internal thread 6.

For the bidirectional tapered external thread and traditional thread connection pair 10 in this embodiment, the conical cone 7 reaches a certain taper, that is, the cones reach a certain taper angle. The thread connection pair 10 can have self-locking and self-positioning properties. The taper comprises the left taper 95 and the right taper 96. The taper angle comprises the left taper angle and the right taper angle. The left taper 95 corresponds to the left taper angle, that is, the first taper angle α1, preferably, the first taper angle α1 is greater than 0° and less than 53°, preferably, the first taper angle α1 takes a value of 2°-40°. In individual special fields, that is, connection application fields where self-locking is not required and/or self-positioning is required to be weak and/or axial bearing capacity is required to be high, preferably, the first taper angle α1 is greater than or equal to 53° and less than 180°, preferably, the first taper angle α1 takes a value of 53°-90°; the right taper 96 corresponds to the right taper angle, that is, the second taper angle α2, preferably, the second taper angle α2 is greater than 0° and less than 53°, preferably, the second taper angle α2 takes a value of 2°-40°.

The internal thread 6 is provided on the inner surface of the cylindrical body 2, wherein the cylindrical body 2 comprises a nut 21, and a traditional inner thread 6 is provided on the inner surface of the nut 21. The traditional thread comprises triangular threads, trapezoidal threads, sawtooth threads, and other geometric forms of threads which can be screwed with the bidirectional tapered threads 1 to form a thread connection pair 10. When the traditional internal thread 6 and the bidirectional tapered external thread 9 cooperate to form a thread connection pair 10, the traditional internal thread 6 at this time is not a traditional thread in the original sense, but a special form of tapered thread 1. The contact part with the bidirectional tapered external thread 9 forms the special tapered hole 4 of the traditional internal thread 6 of the thread connection pair 10 with a special conical surface 42 on the special tapered hole 4. With the increase in the number of screwing and using, the effective conical surface area of the special conical surface 42 on the special tapered hole 4 of the traditional internal thread 6 will continue to increase, that is, the special conical surface 42 will continue to increase and tend to have a greater change in the direction of the contact surface with the conical surface of the bidirectional tapered external threaded 9, essentially forming a special tapered hole that has the technical spirit of the present invention although the tapered geometry is incomplete. The inner conical surface, that is, the special conical surface 42 of the traditional internal thread 6, first appears in the form of a line, and the internal conical surface gradually increases while the number of times of contact between the traditional internal thread 6 tooth tip and the bidirectional tapered external thread 9 truncated cone 7 increases. That is, the special conical surface 42 of the traditional internal thread 6 continues to change and increase from a line to a surface. It is also possible to directly process the inner conical surface matching the bidirectional tapered external thread 9 on the tooth tip of the traditional internal thread 6, which complies with the technical spirit of the present invention. The cylindrical body 2 comprises workpieces and objects such as a cylinder and/or non-cylinder that need to process the internal thread on the inner surface.

The external thread 9 is provided on the outer surface of the columnar body 3, wherein the columnar body 3 has a screw 31. The truncated cone 7 is spirally distributed on the outer surface of the screw 31. The truncated cone 7 comprises a bidirectional truncated cone 71. The columnar body 3 can be solid or hollow, comprising workpieces and objects such as a cylinder and/or a cone, a pipe that need to process the external thread on the outer surface.

The dumbbell-shaped 94 bidirectional truncated cone 71 is formed in which two truncated cones with the same lower bottom surfaces and the same upper top surfaces but different cone heights have symmetrical upper top surfaces which are oppositely joined and lower bottom surfaces which are located at both ends of the bidirectional truncated cone 71 and are mutually joined with the lower bottom surface of the adjacent bidirectional truncated cone 71 and/or are mutually joined with the lower bottom surface of the adjacent bidirectional truncated cone 71 when forming an asymmetrical bidirectional tapered thread 1. The external threads 9 comprise a first spiral conical surface 721 of the truncated cone and a second spiral conical surface 722 of the truncated cone and the outer spiral line 8. In the section passing through the thread axis 02, the whole single-section asymmetric bidirectional tapered external thread 9 is a dumbbell-shaped 94 special bidirectional tapered geometry having a small middle and two large ends. The asymmetric bidirectional truncated cone 71 comprises the conical surface 72 of a bidirectional truncated cone. The included angle between two element lines of the conical surface of the left side, namely the first spiral conical surface 721 of the truncated cone, is the first taper angle α1. The first spiral conical surface 721 of the truncated cone forms the left taper 95 and is distributed in the right direction 98. The included angle between two element lines of the conical surface of the right side, namely the second spiral conical surface 722 of the truncated cone, is the second taper angle α2. The second spiral conical surface 722 of the truncated cone forms the right taper 96 and is distributed in the left direction 97. The first taper angle α1 and the second taper angle α2 correspond to the opposite taper direction. The element line is the intersection of the conical surface and the plane passing through the conical axis 01. The shape formed by the first spiral conical surface 721 of the truncated cone and the second spiral conical surface 722 of the truncated cone of the bidirectional truncated cone 71 is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body 3, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body 3 at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

When the bidirectional tapered external thread and the traditional thread are connected in transmission, the special tapered hole 4 of the traditional internal thread 6 is screwed and connected to the bidirectional truncated cone 71, which bears in both directions. When the external thread 9 and the internal thread 6 form a thread pair 10, there must be a clearance 101 between the bidirectional truncated cone 71 and the special tapered hole 4 of the traditional internal thread 6. If there is oil and other media lubrication between the internal thread 6 and the external thread 9, it will easily form a bearing oil film. The clearance 101 is conducive to the formation of the bearing oil film. The thread connection pair 10 is equivalent to a set of sliding bearing pairs formed by one pair or several pairs of sliding bearings, that is, each section of traditional internal thread 6 bidirectionally contains a corresponding section of bidirectional tapered external thread 9 to form a pair of sliding bearings. The number of the formed sliding bearings is adjusted according to the application conditions, that is, the number of the containing and contained threaded section of the effective bidirectional engagement of the traditional tapered internal thread 6 and the bidirectional tapered external thread 9, which is the effective bidirectional contact envelopment, is designed according to the application conditions. The special tapered hole 4 bidirectionally contains the truncated cone 7 and is positioned in multiple directions such as in radial, axial, angular, and circumferential directions. A special combining technology of the conical pair and the thread pair is formed to ensure the accuracy, efficiency and reliability of transmission connection of the tapered thread technology, especially the bidirectional tapered external thread and the traditional thread.

When the bidirectional tapered external thread and the traditional thread are connected in a fastened and sealed manner, its technical performance is realized by the screw connection of the special tapered hole 4 of the traditional internal thread 6 and the bidirectional truncated cone 71, that is, the first spiral conical surface 721 of the truncated cone and the special conical surface 42 of the special tapered hole 4 of the traditional internal thread 6 are sized until the interference is achieved, and/or the second spiral conical surface 722 of the truncated cone and the special conical surface 42 of the special tapered hole 4 of the traditional internal thread 6 are sized until the interference is achieved. According to the application conditions, bearing is achieved in one direction and/or in two directions simultaneously. That is, the bidirectional truncated cone 71 of the bidirectional tapered external thread 9 and the special tapered hole 4 of the traditional internal thread 6 are guided by the spiral line, and the inner and outer diameters of the inner cone and the outer cone are centered until the special conical surface 42 of the special tapered hole 4 of the traditional internal thread 6 and the first spiral conical surface 721 of the truncated cone are enveloped, until the interference contact is achieved, and/or the special conical surface 42 of the special tapered hole 4 of the traditional internal thread 6 and the second spiral conical surface 722 of the truncated cone are enveloped until the interference contact is achieved, so as to realize the technical performance of mechanical mechanism connection, locking, anti-loosening, bearing, fatigue and sealing.

Therefore, for the mechanism structure of the bidirectional tapered external thread and traditional thread connection pair 10 in this embodiment, the technical performance, such as the transmission accuracy and transmission efficiency, the bearing capacity, the self-locking force, the anti-loosening capacity, the sealing property, and reusability is related to the first spiral conical surface 721 of the truncated cone and the formed left taper 95, that is, the corresponding first taper angle α1, and the second spiral conical surface 722 of the truncated cone and the formed right taper 96, that is, the corresponding second taper angle α2, and is also related to the special conical surface 42 of the special tapered hole 4 of the traditional internal thread 6 and the taper formed by contacting the traditional internal thread 6 and the bidirectional tapered external thread 9. The material friction coefficient, processing quality and application conditions of the columnar body 3 and the cylindrical body 2 also have a certain influence on the cooperation of the cone.

In the bidirectional tapered external thread and the traditional thread, when the right-angled trapezoid combination rotates at a uniform speed for a circle, the axial movement distance of the right-angled trapezoidal combination is at least twice the length of the sum of the right-angle sides of the two right-angled trapezoids with the same lower bottom lines and the same upper bottom lines but different right-angled sides. This structure ensures that the first spiral conical surface 721 of the truncated cone and the second spiral conical surface 722 of the truncated cone have sufficient length, thereby ensuring that when the conical surface 72 of the bidirectional truncated cone is matched with the special conical surface 42 of the special tapered hole 4 of the traditional internal thread 6, it has sufficient effective contact area and strength as well as the efficiency required for spiral movement.

In the bidirectional tapered external thread and the traditional thread, when the right-angled trapezoid combination rotates at a uniform speed for a circle, the axial movement distance of the right-angled trapezoidal combination is equal to the length of the sum of the right-angle sides of the two right-angled trapezoids with the same lower bottom lines and the same upper bottom lines but different right-angled sides. This structure ensures that the first spiral conical surface 721 of the truncated cone and the second spiral conical surface 722 of the truncated cone have sufficient length, thereby ensuring that when the conical surface 72 of the bidirectional truncated cone is matched with the special conical surface 42 of the special tapered hole 4 of the traditional internal thread 6, it has sufficient effective contact area and strength as well as the efficiency required for spiral movement.

In the bidirectional tapered external thread and the traditional thread, the first spiral conical surface 721 of the truncated cone and the second spiral conical surface 722 of the truncated cone are both continuous spiral surfaces or discontinuous spiral surfaces.

In the bidirectional tapered external thread and the traditional thread, one end and/or both ends of the columnar body 3 can be screwed into the screwing end of the connecting hole of the cylindrical body 2. The connecting hole is a threaded hole provided on the nut 21. One end of the columnar body 3 is provided with a head having a size larger than the outer diameter of the columnar body 3 and/or one end and/or both ends of the columnar body 3 are provided with a head smaller than the small diameter of the external thread 9 of the columnar body 3 screw 31. That is, the columnar body 3 herein connected to the head is a bolt. The columnar body having no head and/or having the heads at both ends smaller than the small diameter of the external thread 9 and/or having no thread in the middle but having external threads 9 at both ends is a bolt.

Compared with the prior art, the advantages of the bidirectional tapered external thread and traditional thread connection pair 10 are as follows: the design is reasonable, the structure is simple, the conical pair formed by the inner and outer cones is sized until there is interference fit to realize the function of fastening and connection, it is convenient to operate, the locking force is large, the bearing value is large, the anti-loose performance is good, the transmission efficiency and the precision are high, the mechanical sealing effect is good, the stability is, good, the loosening phenomenon can be prevented during connection, and there are self-locking and self-positioning functions.

### Embodiment 2

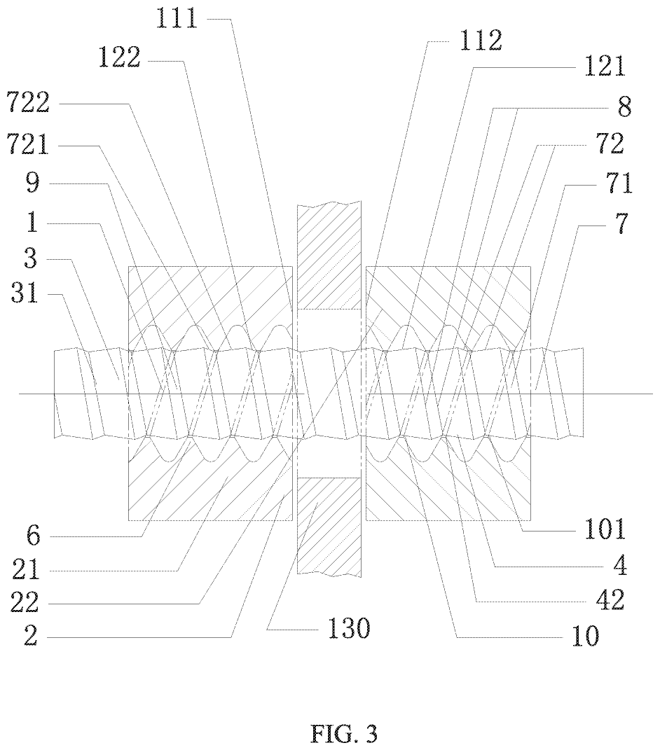

As shown in FIG. 3, the structure, principle and implementation steps of this embodiment are similar to those of Embodiment 1. The difference is that this embodiment adopts an asymmetric bidirectional tapered external thread 9 bolt-traditional internal thread 6 double-nut connection structure. The double nuts comprise a nut 21 and a nut 22. The nut 21 is located on the left side of the fastened workpiece 130, and the nut 22 is located on the right side of the fastened workpiece 130. When the bolt and the double-nut connection structure are working, the relationship with the fastened workpiece 130 is a rigid connection. The rigid connection means that the supporting surface of the nut end face and the supporting surface of the workpiece 130 are mutually supporting surfaces, comprising the locking supporting surface 111 and the locking supporting surface 112. The workpiece 130 refers to the connected object comprising the workpiece 130.

The threaded working supporting surfaces of this embodiment are different, comprising the tapered thread supporting surface 121 and the tapered thread supporting surface 122. When the cylindrical body 2 is located on the left side of the fastened workpiece 130, that is, when the left end surface of the fastened workpiece 130 and the right end surface of the cylindrical body 2, that is, the left nut 21, are the locking supporting surfaces 111 of the left nut 21 and the fastened workpiece 130, the columnar body 3, that is, the screw 31, that is, the spiral conical surface of the left side of the bidirectional tapered thread 1 of the bolt, is the threaded working supporting surface, that is, the tapered thread supporting surface 122 is the thread supporting surface. The special conical surface 42 of the traditional internal thread 6 and the first spiral conical surface 721 of the truncated cone are the tapered thread supporting surfaces 122, and the special conical surface 42 of the traditional internal thread 6 and the first spiral conical surface 721 of the truncated cone are the mutually supporting surfaces. When the cylindrical body 2 is located on the right side of the fastened workpiece 130, that is, when the right end surface of the fastened workpiece 130 and the left end surface of the cylindrical body 2, that is, the right nut 22, are the locking supporting surface 112 of the right nut 22 and the fastened workpiece 130, the columnar body 3, that is, the screw 31, that is, the spiral conical surface of the right side of the bidirectional tapered thread 1 of the bolt, is the threaded working supporting surface. The tapered thread supporting surfaces 121 is the threaded working supporting surface. The special conical surface 42 of the traditional internal thread 6 and the second spiral conical surface 722 of the truncated cone of the tapered external thread 9 are the tapered thread supporting surfaces 121, and the special conical surface 42 of the traditional internal thread 6 and the second spiral conical surface 722 of the truncated cone are the mutually supporting surfaces.

The connecting hole is provided in the nut 21 and the nut 22.

### Embodiment 3

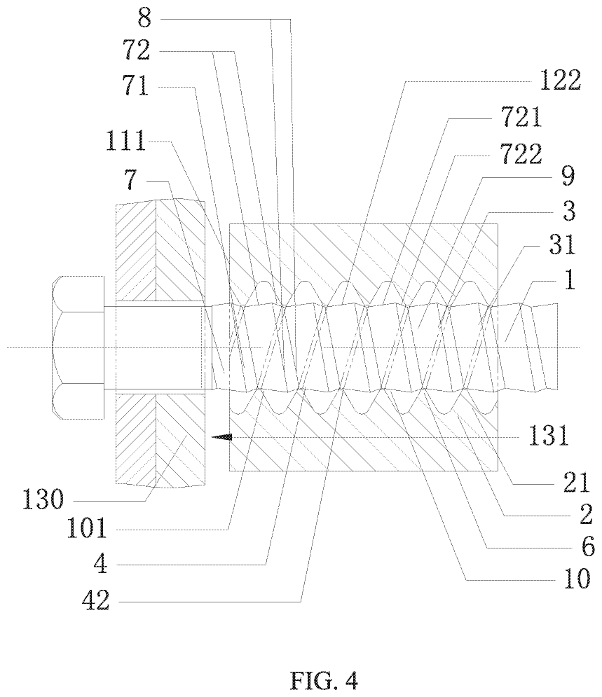

As shown in FIG. 4, the structure, principle and implementation steps of this embodiment are similar to those of Embodiment 1 and Embodiment 2. The difference is that this embodiment adopts an asymmetric bidirectional tapered thread 1 bolt-traditional thread single-nut connection structure, and the bolt has a hexagonal head larger than the screw 31. When the hexagon head of the bolt is on the left side, the cylindrical body 2, that is the nut 21, that is, the single nut, is located on the right side of the fastened workpiece 130. When the bolt and the single nut of this embodiment work, the relationship with the fastened workpiece 130 is rigid connection. The rigid connection means that the end face of the nut 21 and the opposite end surfaces of the end face of the workpiece 130 are mutually supporting surfaces. The supporting surface is the locking supporting surface 111. The workpiece 130 refers to a connected object comprising the workpiece 130.

The threaded working supporting surface of this embodiment is the tapered threaded supporting surface 122, that is, the cylindrical body 2, that is, the nut 21, that is, the single nut, is located on the right side of the fastened workpiece 130. When the bolt-single nut connection structure works, the right end surface of the workpiece 130 and the left end surface of the nut 21 are the locking supporting surfaces 111 of the nut 21 and the fastened workpiece 130. The right spiral conical surface of the columnar body 3, that is, the screw 31, that is, the bidirectional tapered thread 1 of the bolt, is the threaded working supporting surface, that is, the tapered thread supporting surface 122 is the working supporting surface of the bidirectional tapered thread 1. The special conical surface 42 of the traditional internal thread 6 and the second spiral conical surface 722 of the truncated cone are the tapered thread supporting surfaces 122, and the special conical surface 42 of the traditional internal thread 6 and the second spiral conical surfaces 722 of the truncated cone are mutually supporting surfaces.

In this embodiment, when the hexagon head of the bolt is located on the right side, its structure, principle and implementation steps are similar to those of this embodiment.

### Embodiment 4

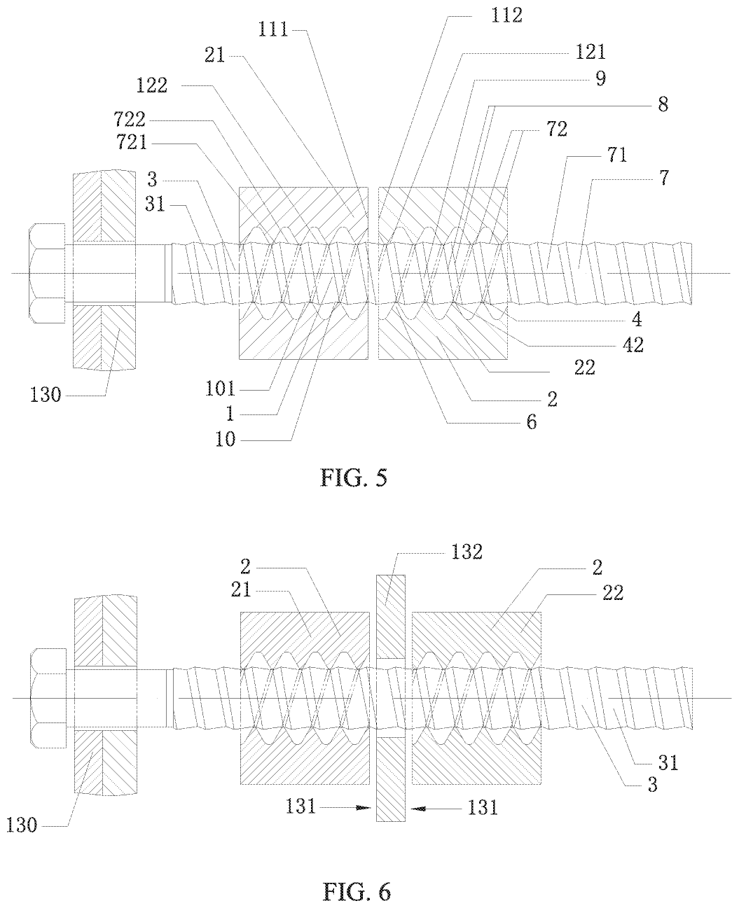

As shown in FIG. 5, the structure, principle and implementation steps of this embodiment are similar to those of Embodiment 1 and Embodiment 2. The difference is that the positional relationship between the double nuts and the fastened workpiece 130 is different. The double nuts comprise a nut 21 and a nut 22. The bolt has a hexagonal head larger than the screw 31. When the hexagonal head of the bolt is on the left side, the nut 21 and the nut 22 are both on the right side of the fastened workpiece 130. When the bolt and double nuts work, the relationship between the nut 21, the nut 22 and the fastened workpiece 130 is, non-rigid connection. The non-rigid connection means that the opposite side surfaces of the two nuts, namely the nut 21 and the nut 22, are mutually supporting surfaces. The supporting surface comprises a locking supporting surface 111 and a locking supporting surface 112, which is mainly used in non-rigid materials or non-rigid connection workpieces 130 such as transmission parts, or application fields in which installation is achieved by double nuts to meet requirements. The workpiece 130 refers to the connected object comprising the workpiece 130.

The threaded working supporting surface of this embodiment is different, comprising a tapered thread supporting surface 121 and a tapered thread supporting surface 122. The cylindrical body 2 comprises a left nut 21 and a right nut 22. The right end surface of the left nut 21 (that is, the locking supporting surface 111) and the left end surface of the right nut 22 (that is, the locking supporting surface 112) are in direct contact with each other oppositely and are mutually locking supporting surfaces. When the right end surface of the left nut 21 is a locking support supporting surface 111, the columnar body 3, that is, the screw 31, that is, the spiral conical surface of the left side of the bidirectional tapered thread 1 of the bolt, is the threaded working supporting surface, that is, the tapered thread supporting surface 122 is the working supporting surface. The special conical surface 42 of the traditional internal thread 6 and the first spiral conical surface 721 of the truncated cone of the tapered external thread 9 are the tapered thread supporting surfaces 122, and the special conical surface 42 of the traditional internal thread 6 and the first spiral conical surface 721 of the truncated cone are the mutually supporting surfaces. When the left end surface of the right nut 22 is a locking support supporting surface 112, the columnar body 3, that is, the screw 31, that is, the spiral conical surface of the right side of the bidirectional tapered thread 1 of the bolt, is the threaded working supporting surface, that is, the tapered thread supporting surface 121 is the thread working supporting surface. The special conical surface 42 of the traditional internal thread 6 and the second spiral conical surface 722 of the truncated cone of the tapered external thread 9 are the tapered thread supporting surfaces 121, and the special conical surface 42 of the traditional internal thread 6 and the second spiral conical surface 722 of the truncated cone are the mutually supporting surfaces.

In this embodiment, when the cylindrical body 2 on the inner side, that is, the nut 21 adjacent to the fastened workpiece 130, is effectively combined with the columnar body 3, that is, the screw 31, that is, the bolt, the internal thread 6 and the external thread 9 forming the thread connection pair 10 are effectively enveloped together. The cylindrical body 2 on the outer side, that is, the nut 22 that is not adjacent to the fastened workpiece 130, needs to remain intact and/or be disassembled, leaving only one nut according to the application working conditions (for example, the application fields that require lightweight devices or do not require double nuts to ensure the reliability of the connection technology). The removed nut 22 is not used as a connecting nut, but is only used as an installation process nut. The internal thread of the installation process nut is not only made of a traditional thread, but also is the nut 22 made of the bidirectional tapered thread 1 and the unidirection tapered thread that can be screwed with the bolt thread. On the premise of ensuring the reliability of the connection technology, the thread connection pair 10 is a closed-loop fastening technology system, that is, after the internal thread 6 and the external thread 9 of the thread connection pair 10 are effectively enveloped together, the thread connection pair 10 will become an independent technical system without relying on the technical compensation of the third party to ensure the technical validity of the connection technology system. Even if there is no support from other objects, the gap between the thread connection pair 10 and the fastened workpiece 130 will not affect the effectiveness of the thread connection pair 10. This will help greatly reduce the weight of the device, remove the ineffective load, and improve the technical requirements such as the effective load capacity, braking property, and energy conservation and emission reduction of the device. This is the advantage of thread technology that is unique no matter when the relationship between the thread connection pair 10 and the fastened workpiece 130 of the connection structure of the bidirectional tapered external thread and the traditional thread is non-rigid connection or rigid connection, and that other thread technologies do not have.

In this embodiment, when the hexagon head of the bolt is located on the right side, the nut 21 and the nut 22 are both located on the left side of the fastened workpiece 130, and the structure, principle and implementation steps are similar to those of this embodiment.

### Embodiment 5

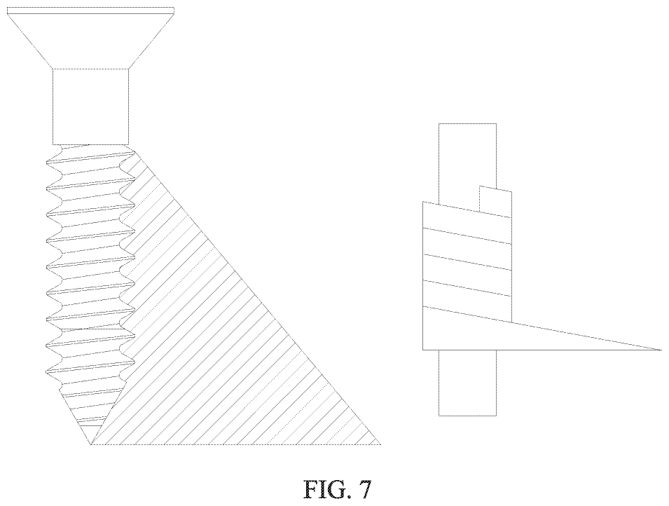

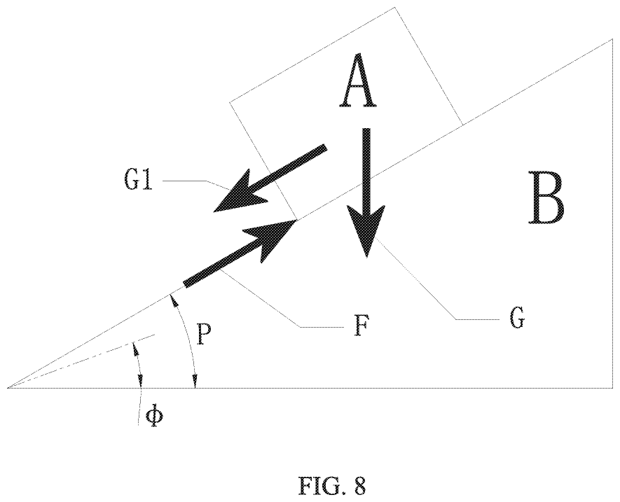

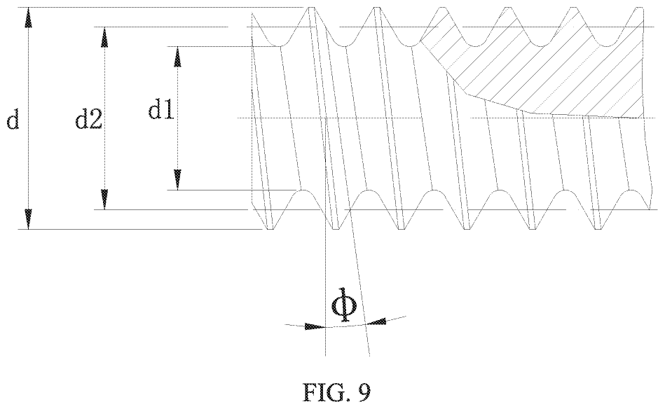

As shown in FIG. 6, the structure, principle, and implementation steps of this embodiment are similar to those of Embodiment 1 and 4. The difference is that based on the Embodiment 4, this embodiment adds spacers such as washers 132 between the nut 21 and the nut 22. That is, the right end surface of the left nut 21 and the left end surface of the right nut 22 are in indirect contact with each other oppositely through the washer 132, thereby indirectly acting as a mutually locking supporting surface. That is, the mutual relationship between the right end surface of the left nut 21 and the left side end surface of the right nut 22 has changed from the direct mutually locking supporting surface to the indirect mutually locking supporting surface.

The specific embodiments described herein are merely examples to illustrate the spirit of the present invention. Those skilled in the art to which the present invention pertains can make various modifications or additions to the described specific embodiments or use similar alternatives, but they will not deviate from the spirit of the present invention or exceed the scope defined by the appended claims.

Although the present invention more widely uses tapered thread 1, cylindrical body 2, nut 21, nut 22, columnar body 3, screw 31, special tapered hole 4, special conical surface 42, internal thread 6, truncated cone 7, bidirectional truncated cone 71, conical surface of bidirectional truncated cone 72, first spiral conical surface of truncated cone 721, first taper angle α1, second spiral conical surface of truncated cone 722, second taper angle α2, external spiral line 8, external thread 9, dumbbell-shaped 94, left taper 95, right taper 96, left distribution 97, right distribution 98, thread connection pair and/or thread pair 10, clearance 101, self-locking force, self-locking, self-positioning, intensity of pressure, conical axis 01, thread axis 02, mirror image, bushing, shaft, single-tapered body, double-tapered body, cone, inner cone, tapered hole, outer cone, cone, conical pair, spiral structure, spiral movement, thread, complete unit body thread, axial force, axial force angle, anti-axial force, anti-axial force angle, centripetal force, anti-centripetal central force, oppositely collinear, internal stress, bidirectional force, unidirection force, sliding bearing, sliding bearing pair, locking supporting surface 111, locking supporting surface 112, tapered thread supporting surface 122, tapered thread supporting surface 121, non-solid space, material entity, workpiece 130, nut locking direction 131, non-rigid connection, non-rigid material, transmission part, washer 132, etc., the possibility of using other terms is not excluded. These terms are used only for more convenient description and explanation of the essence of the present invention, and interpreting them as any additional limitation is contrary to the spirit of the present invention.

What is claimed is:

1. A connection structure having a dumbbell-shaped bidirectional tapered external thread and a traditional thread having a large left taper and a small right taper, which is connection structure having a dumbbell-shaped (the left taper is greater than the right taper) asymmetric bidirectional tapered external thread and a traditional thread, comprising an internal thread (6) and an external thread (9) which are in screw-thread fit with each other;
wherein the complete unit body thread of the dumbbell-shaped (the left taper is greater than the right taper) asymmetric bidirectional tapered external thread (9) is a spiral dumbbell-shaped (94) asymmetric bidirectional truncated cone (71) having a small middle and two large ends, the left taper (95) is greater than the right taper (96), the thread of the external thread (9) is a columnar body (3) with a spiral bidirectional truncated cone (71) on the outer surface and exists in the form of a “material entity”, the thread of the internal thread (6) is a cylindrical body (2) with a spiral special tapered hole (41) formed in such a manner that the tooth body of the original traditional internal thread (6) is assimilated due to being in enveloping contact with the bidirectional tapered external thread (9) on the inner surface and exists in the form of “non-solid space”, the left conical surface of the external thread (9) of the asymmetric bidirectional tapered body forms a first taper angle (α1) corresponding to the left taper (95), the right conical surface forms a second taper angle (α2) corresponding to the right taper (96), the left taper (95) and the right taper (96) have opposite directions and different sizes, the internal thread (6) and the external thread (9) enclose the tapered body through the tapered hole until the inner and outer conical surfaces bear mutually, the technical performance mainly depends on the conical surfaces and the taper sizes of the threads matching with each other, preferably, the first taper angle (α1) is greater than 0° and less than 53°, the second taper angle (α2) is greater than 0° and less than 53°, and for individual special fields, preferably, the first taper angle (α1) is greater than or equal to 53° and less than 180°.

2. The connection structure of claim 1, wherein the dumbbell-shaped (94) bidirectional tapered external thread (9) comprises a left conical surface of a conical surface (72) of the bidirectional truncated cone, which is a first spiral conical surface (721) of the truncated cone, a right conical surface, which is a second spiral conical surface (722) of the truncated cone, and an outer spiral line (8), the shape formed by the first spiral conical surface (721) of the truncated cone and the second spiral conical surface (722) of the truncated cone, that is, the bidirectional spiral conical surface, is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body (3), of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body (3) at a uniform speed.

3. The connection structure of claim 2, wherein when the right-angled trapezoid combination rotates at a uniform speed for a circle, the axial movement distance of the right-angled trapezoidal combination is at least twice the length of the sum of the two right-angled trapezoidal right-angle sides of the right-angled trapezoidal combination.

4. The connection structure of claim 2, wherein when the right-angled trapezoidal combination rotates at a constant speed for a circle, the axial movement distance of the right-angled trapezoidal combination is equal to the length of the sum of the two right-angled trapezoidal right-angle sides of the right-angled trapezoidal combination.

5. The connection structure of claim 2, wherein the left conical surface and the right conical surface of the asymmetric bidirectional tapered external thread (9), which are the first spiral conical surface (721) of the truncated cone and the second spiral conical surface (722) of the truncated cone and the outer spiral (8), and the outer spiral line (8) are all continuous spiral surfaces or discontinuous spiral surfaces; the special tapered hole (4) has a special conical surface (42), and the special conical surface (42) is a continuous spiral surface or a discontinuous spiral surface.

6. The connection structure of claim 1, wherein the external thread (9) is a dumbbell-shaped (94) asymmetrical bidirectional tapered external thread (9) formed in a spiral shape in which two truncated cones (7) with the same lower bottom surfaces and the same upper top surfaces but different cone heights have symmetrical upper top surfaces which are mutually oppositely joined and lower bottom surfaces which are located at both ends of the bidirectional truncated cone (71) and are mutually joined with the lower bottom surface of the adjacent bidirectional truncated cone (71) and/or are mutually joined with the lower bottom surface of the adjacent bidirectional truncated cone (71) when forming a dumbbell-shaped (94) asymmetrical bidirectional tapered thread (1).

7. The connection structure of claim 1, wherein the traditional thread comprises any of a triangular thread, a trapezoidal thread, a sawtooth thread, a rectangular thread, and a circular arc thread, but is not limited to the above threads, which is applicable to the traditional thread which uses and comprises its thread, that is, the tooth undergoing deformation treatment, and which complies with the technical spirit of the present invention since such deformation treatment is in screw-thread fit with the bidirectional tapered external thread (9).

8. The connection structure of claim 1, wherein the bidirectional tapered external thread (9) has the ability to assimilate a traditional internal thread (6), the single-section thread body is an incomplete tapered geometry, that is, the single-section thread body is an incomplete unit body thread, after being assimilated, the traditional internal thread (6) is an alienated traditional thread, that is, the thread body is a special form of tapered thread (1), the internal thread (6) and the external thread (9) form a thread pair (10), the spiral bidirectional truncated cone (71) and the special tapered hole (4) are matched with each other to form sections of the cone pair to form the thread pair (10), the special conical surface (42), the first spiral conical surface (721) of the truncated cone and the second spiral conical surface (722) of the truncated cone take the contact surface as the supporting surface, the inner and outer diameters of the inner cone and outer cone are centered when being guided by the spiral line until the conical surface (72) of the bidirectional truncated cone and the special conical surface (42) are enveloped so that the spiral conical surface bears in one direction and/or the spiral conical surface bears in two directions simultaneously and/or until the size realizes self-positioning contact and/or the size realizes interference contact to be self-locked.

9. The connection structure of claim 1, wherein when a cylindrical body (2) has been effectively combined with the columnar body (3), the internal thread (6) and the external thread (9) forming the thread connection pair (10) are effectively enveloped together, the other cylindrical body (2) can be removed and/or retained, the removed cylindrical body (2) is used as an installation process nut, and the internal thread comprises a traditional thread and is also made of the unidirection tapered thread and the bidirectional tapered thread (1) capable of being screw-thread fit with the thread of the columnar body (3).

10. The connection structure of claim 1, wherein the columnar body (3) can be solid or hollow, comprising workpieces and objects such as a cylinder and/or non-cylinder that need to process the bidirectional tapered external thread (9) on the outer surface, and the outer surface comprises the outer surface geometrical shape such as a cylindrical surface or a non-cylindrical surface such as a conical surface.
